(19) United States
(12) Patent Application Publication
(10) Pub. No.: US 2017/0197782 A1
(43) Pub. Date: Jul. 13, 2017

(54) Combination Trash Liner Storage and Trash Receptacle

(71) Applicant: Tracy L. Reith, McKeesport, PA (US)

(72) Inventor: Tracy L. Reith, McKeesport, PA (US)

(21) Appl. No.: 14/992,079

(22) Filed: Jan. 11, 2016

(51) Int. Cl. B65F 1/06; B65F 1/14

(52) U.S. Cl. CPC B65F 1/062; B65F 1/14

(57) ABSTRACT

A combination trash liner storage and trash receptacle having integrated trash liner storage includes a housing that comprises a wall extending upwardly from a bottom defining an open top. Each of a plurality of fasteners is coupled to an interior surface of the housing proximate to a bottom of the housing. Each fastener is positioned equally distant from the bottom defining an internal perimeter of the housing. A panel that is substantially complementary to the internal perimeter is reversibly couplable to the fasteners. The fasteners are positioned on the interior wall such that the panel is couplable to the fasteners to position the panel in substantial parallelism with the bottom. A slot is positioned in the panel for insertion of an end of a roll of trash can liners. A plurality of penetrations is positioned in the wall to allow air to pass through the wall of the housing.

BACKGROUND OF THE DISCLOSURE

### Field of the Disclosure

The disclosure relates to trash receptacles and more particularly pertains to a new trash receptacle having integrated trash liner storage.

SUMMARY OF THE DISCLOSURE

An embodiment of the disclosure meets the needs presented above by generally comprising a housing that comprises a wall extending upwardly from a bottom defining an open top. Each of a plurality of fasteners is coupled to an interior surface of the housing proximate to a bottom of the housing. Each fastener is positioned equally distant from the bottom defining an internal perimeter of the housing. A panel that is substantially complementary to the internal perimeter is reversibly couplable to the fasteners. The fasteners are positioned on the interior wall such that the panel is couplable to the fasteners to position the panel in substantial parallelism with the bottom. A slot is positioned in the panel for insertion of an end of a roll of trash can liners. A plurality of penetrations is positioned in the wall to allow air to pass through the wall of the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a cut-away view of a Combination trash liner storage and trash receptacle according to an embodiment of the disclosure.

FIG. 2 is a cut-away view of an embodiment of the disclosure.

FIG. 3 is a side view of an embodiment of the disclosure.

FIG. 4 is a top view of an embodiment of the disclosure.

FIG. 5 is a cross-sectional view of an embodiment of the disclosure.

### DESCRIPTION OF THE PREFERRED EMBODIMENT

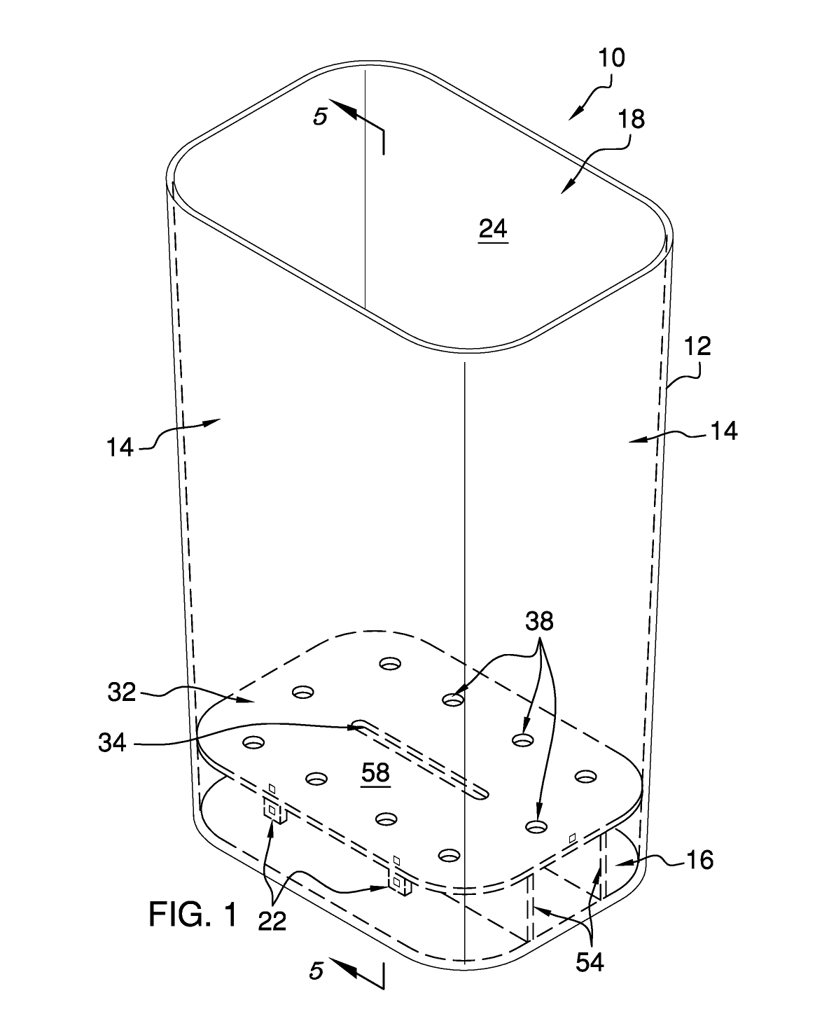

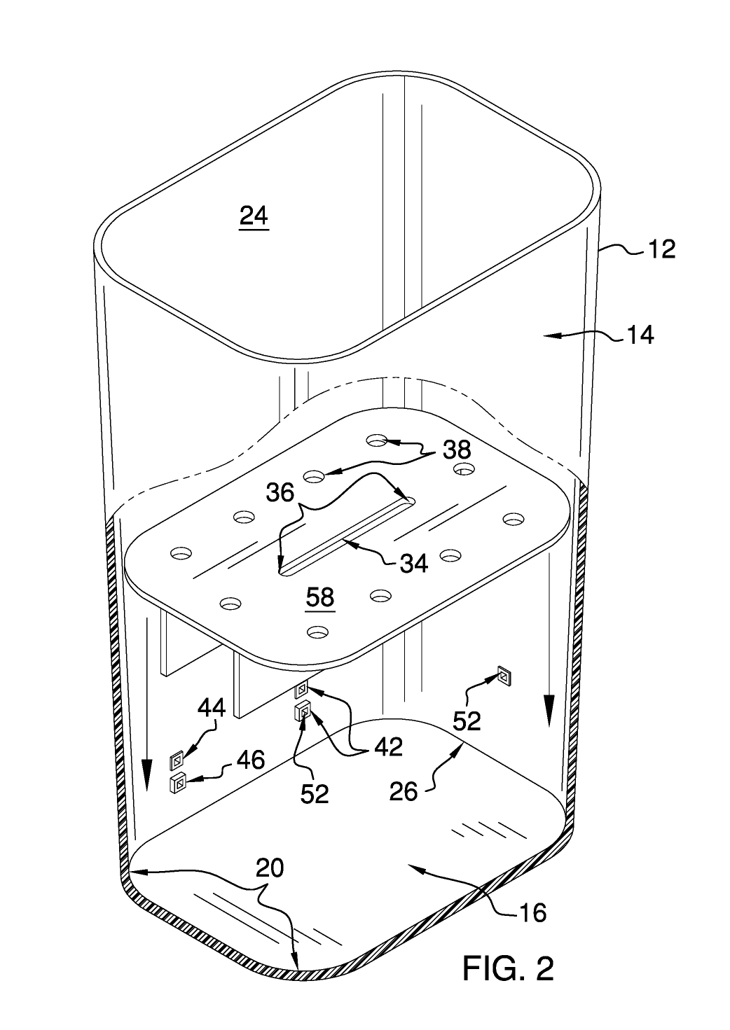

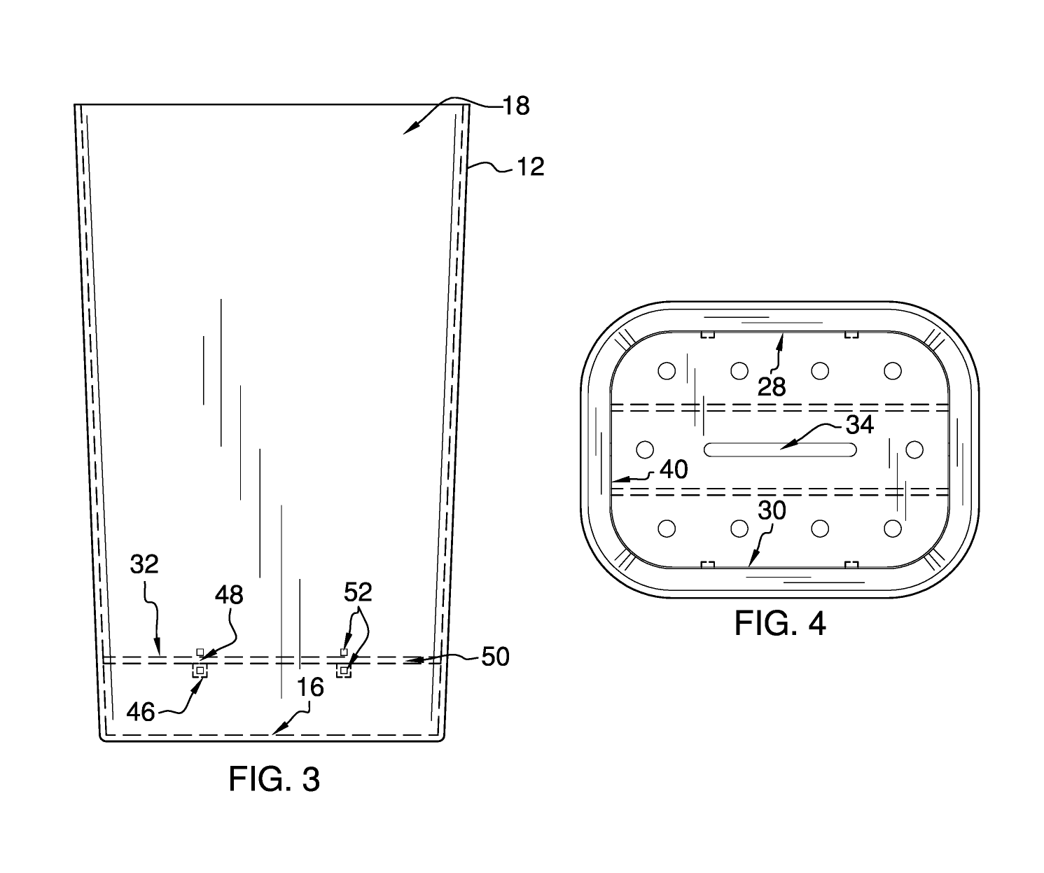

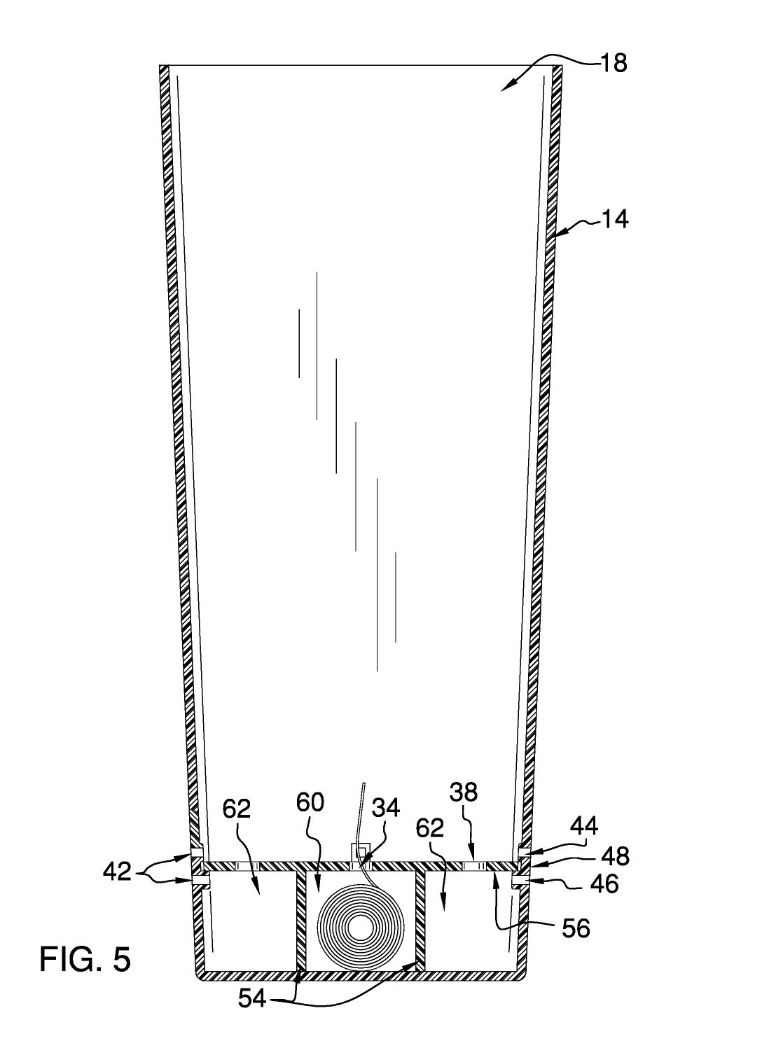

With reference now to the drawings, and in particular to FIGS. 1 through 5 thereof, a new trash receptacle embodying the principles and concepts of an embodiment of the disclosure and generally designated by the reference numeral 10 will be described.

As best illustrated in FIGS. 1 through 5, the combination trash liner storage and trash receptacle 10 generally comprises a housing that comprises a wall extending upwardly from a bottom defining an open top. Preferably, the bottom is substantially rectangular, such that the housing is substantially rectangularly box shaped. Also preferably, the bottom has rounded corners.

Each of a plurality of fasteners is coupled to an interior surface of the housing proximate to a bottom of the housing. Each of the plurality of fasteners is positioned equally distant from the bottom defining an internal perimeter of the housing. Preferably, the plurality of fasteners comprises four fasteners. Two of the fasteners are coupled to a first opposing wall of the housing and another two of the fasteners are coupled to a second opposing wall of the housing. A respective fastener coupled to the first opposing wall is aligned with a respective fastener coupled to the second opposing wall.

The receptacle 10 comprises a panel that is substantially complementary to the internal perimeter. The panel is reversibly couplable to the fasteners to position the panel in substantial parallelism with the bottom. A slot is positioned in the panel. Preferably, the slot is substantially centrally positioned in the panel. The slot is elongated and has rounded ends.

A plurality of holes is positioned through the panel between the slot and an edge of the panel. Preferably, the holes are substantially circular and substantially evenly spaced. The plurality of holes comprises between four and twenty holes. Preferably, the plurality of holes comprises between eight and twelve holes. More preferably, the plurality of holes comprises ten holes.

Each fastener may comprise a pair of extrusions. Each of the pair of extrusions is vertically aligned defining an upper extrusion and a lower extrusion. The upper extrusion and the lower extrusion are separated by a gap that is complementary to a thickness of the panel. The lower extrusion extends from the wall further than the upper extrusion. The upper extrusion is deformable, such that the panel is insertable through the open top of the housing and positionable in the gap. The lower extrusions and the upper extrusions retain the panel in the gap. Preferably, the extrusions are substantially rectangular.

A plurality of penetrations is positioned in the wall. The penetrations are configured to allow air to pass through the wall of the housing. Preferably, a penetration is positioned through a respective lower extrusion and a penetration is positioned through a respective upper extrusion. The penetrations are substantially rectangular.

The receptacle 10 may comprise a plurality of slats that is coupled to and extends perpendicularly from a lower face of the panel. The slats are positioned in parallel on the lower face, such that the slats extend from the lower face to the bottom when the panel is positioned in the gap. The slats are positioned on the panel such that the panel is configured to support items placed onto an upper face of the panel. Preferably, the plurality of slats comprises two slats that define a central compartment. The central compartment comprises the slot and is substantially rectangularly box shaped. The slats also define a pair of outer compartments. Preferably, each of the outer compartments and the central compartment are substantially equally sized.

In use, the slot is configured for insertion of an end of a roll of trash can liners such that the roll of trash can liners is positioned adjacent to the lower face of the panel. The panel is insertable through the open top such that the panel is coupled to the fasteners. The open top is configured to couple with the open end of the trash can liner. The penetrations are positioned in the wall such that air can escape through the wall as items are added to the trash can liner.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. Combination trash liner storage and trash receptacle comprising:
a housing, said housing comprising a wall extending upwardly from a bottom defining an open top;
a plurality of fasteners, each said fastener being coupled to an interior surface of said housing proximate to a bottom of said housing, each of said plurality of fasteners being positioned equally distant from said bottom defining an internal perimeter of said housing;
a panel, said panel being substantially complementary to said internal perimeter, said panel being reversibly couplable to said fasteners, wherein said fasteners are positioned on said interior surface such that said panel is couplable to said fasteners to position said panel in substantial parallelism with said bottom;
a slot, said slot being positioned in said panel;
a plurality of penetrations, said penetrations being positioned in said wall, wherein said penetrations are configured to allow air to pass through said wall of said housing;
wherein said slot is configured for insertion of an end of a roll of trash can liners such that the roll of trash can liners is positioned adjacent to said lower face of said panel, wherein said panel is insertable through said open top such that said panel is coupled to said fasteners, wherein said open top is configured to couple with the open end of the trash can liner, and wherein said penetrations are positioned in said wall such that air can escape through said wall as items are added to the trash can liner; and
each said fastener comprising a pair of extrusions, each of said pair of extrusions being vertically aligned defining an upper extrusion and a lower extrusion, said upper extrusion and said lower extrusion being separated by a gap, said gap being complementary to a thickness of said panel, said lower extrusion extending from said wall further than said upper extrusion, said upper extrusion being deformable, wherein said panel is insertable through said open top of said housing, such that said panel is positionable in said gap with said lower extrusions and said upper extrusions retaining said panel in said gap.

2. The receptacle of claim 1, further including said bottom being substantially rectangular, wherein said housing is substantially rectangularly box shaped.

3. The receptacle of claim 2, further including said bottom having rounded corners.

4. The receptacle of claim 2, further including said plurality of fasteners comprising four fasteners, two of said fasteners being coupled to a first opposing wall of said housing, another two of said fasteners being coupled to a second opposing wall of said housing, such that a respective said fastener coupled to said first opposing wall is aligned with a respective said fastener coupled to said second opposing wall.

5. (canceled)

6. The receptacle of claim 1, further including said extrusions being substantially rectangular.

7. The receptacle of claim 1, further including said slot being substantially centrally positioned in said panel.

8. The receptacle of claim 1, further including said slot being elongated, said slot having rounded ends.

9. The receptacle of claim 1, further including a plurality of holes, said holes being positioned through said panel between said slot and an edge of said panel.

10. The receptacle of claim 9, further comprising:
said holes being substantially circular; and
said holes being substantially evenly spaced.

11. The receptacle of claim 9, further including said plurality of holes comprising between four and twenty holes.

12. The receptacle of claim 11, further including said plurality of holes comprising between eight and twelve holes.

13. The receptacle of claim 12, further including said plurality of holes comprising ten holes.

14. The receptacle of claim 1, further including each said penetration being positioned through a respective said lower extrusion.

15. The receptacle of claim 1, further including each said penetration being positioned through a respective said upper extrusion.

16. The receptacle of claim 1 further including said penetrations being substantially rectangular.

17. The receptacle of claim 1, further including a plurality of slats, said slats being coupled to and extending perpendicularly from a lower face of said panel, said slats being positioned in parallel on said lower face, such that said slats extend from said lower face to said bottom when said panel is positioned in said gap, wherein said slats are positioned on said panel such that said panel is configured to support items placed onto an upper face of said panel.

18. Combination trash liner storage and trash receptacle comprising:
a housing, said housing comprising a wall extending upwardly from a bottom defining an open top;
a plurality of fasteners, each said fastener being coupled to an interior surface of said housing proximate to a bottom of said housing, each of said plurality of fasteners being positioned equally distant from said bottom defining an internal perimeter of said housing;
a panel, said panel being substantially complementary to said internal perimeter, said panel being reversibly couplable to said fasteners, wherein said fasteners are positioned on said interior surface such that said panel is couplable to said fasteners to position said panel in substantial parallelism with said bottom;
a slot, said slot being positioned in said panel;
a plurality of penetrations, said penetrations being positioned in said wall, wherein said penetrations are configured to allow air to pass through said wall of said housing;
wherein said slot is configured for insertion of an end of a roll of trash can liners such that the roll of trash can liners is positioned adjacent to said lower face of said panel, wherein said panel is insertable through said open top such that said panel is coupled to said fasteners, wherein said open top is configured to couple with the open end of the trash can liner, and wherein said penetrations are positioned in said wall such that air can escape through said wall as items are added to the trash can liner;
a plurality of slats, said slats being coupled to and extending perpendicularly from a lower face of said panel, said slats being positioned in parallel on said lower face, such that said slats extend from said lower face to said bottom when said panel is positioned in said gap, wherein said slats are positioned on said panel such that said panel is configured to support items placed onto an upper face of said panel, said plurality of slats comprising two slats defining a central compartment, said central compartment comprising said slot, said central compartment being substantially rectangularly box shaped, said slats defining a pair of outer compartments.

19. The receptacle of claim 18, further including each of said outer compartments and said central compartment being substantially equally sized.

20. Combination trash liner storage and trash receptacle comprising:
a housing, said housing comprising a wall extending upwardly from a bottom defining an open top, said bottom being substantially rectangular, wherein said housing is substantially rectangularly box shaped, said bottom having rounded corners;
a plurality of fasteners, each said fastener being coupled to an interior surface of said housing proximate to a bottom of said housing, each of said plurality of fasteners being positioned equally distant from said bottom defining an internal perimeter of said housing, said plurality of fasteners comprising four fasteners, two of said fasteners being coupled to a first opposing wall of said housing, another two of said fasteners being coupled to a second opposing wall of said housing, such that a respective said fastener coupled to said first opposing wall is aligned with a respective said fastener coupled to said second opposing wall;
each said fastener comprising a pair of extrusions, each of said pair of extrusions being vertically aligned defining an upper extrusion and a lower extrusion, said upper extrusion and said lower extrusion being separated by a gap, said gap being complementary to a thickness of said panel, said lower extrusion extending from said wall further than said upper extrusion, said upper extrusion being deformable, wherein said panel is insertable through said open top of said housing, such that said panel is positionable in said gap with said lower extrusions and said upper extrusions retaining said panel in said gap, said extrusions being substantially rectangular;
a panel, said panel being substantially complementary to said internal perimeter, said panel being reversibly couplable to said fasteners, wherein said fasteners are positioned on said interior surface such that said panel is couplable to said fasteners to position said panel in substantial parallelism with said bottom;
a slot, said slot being positioned in said panel, said slot being substantially centrally positioned in said panel, said slot being elongated, said slot having rounded ends;
a plurality of holes, said holes being positioned through said panel between said slot and an edge of said panel, said holes being substantially circular, said holes being substantially evenly spaced, said plurality of holes comprising between eight and twelve holes;
a plurality of penetrations, said penetrations being positioned in said wall, wherein said penetrations are configured to allow air to pass through said wall of said housing, each said penetration being positioned through a respective said lower extrusion, each said penetration being positioned through a respective said upper extrusion, said penetrations being substantially rectangular;
a plurality of slats, said slats being coupled to and extending perpendicularly from a lower face of said panel, said slats being positioned in parallel on said lower face, such that said slats extend from said lower face to said bottom when said panel is positioned in said gap, wherein said slats are positioned on said panel such that said panel is configured to support items placed onto an upper face of said panel, said plurality of slats comprising two slats defining a central compartment, said central compartment comprising said slot, said central compartment being substantially rectangularly box shaped, said slats defining a pair of outer compartments, each of said outer compartments and said central compartment being substantially equally sized; and
wherein said slot is configured for insertion of an end of a roll of trash can liners such that the roll of trash can liners is positioned adjacent to said lower face of said panel, wherein said panel is insertable through said open top such that said panel is coupled to said fasteners, wherein said open top is configured to couple with the open end of the trash can liner, and wherein said penetrations are positioned in said wall such that air can escape through said wall as items are added to the trash can liner.
